(19) United States
(12) Patent Application Publication
(10) Pub. No.: US 2005/0210021 A1
(43) Pub. Date: Sep. 22, 2005

(54) Mobile body navigation system and destination search method for navigation system

(76) Inventors: Yukio Miyazaki, Tokyo (JP); Yoshitaka Atarashi, Tokyo (JP); Manabu Kato, Tokyo (JP)

Correspondence Address: CROWELL & MORING LLP;INTELLECTUAL PROPERTY GROUP, P.O. BOX 14300, WASHINGTON, DC, 20044-4300, US

(21) Appl. No.: 11/056,172

(22) Filed: Feb. 14, 2005

(30) Foreign Application Priority Data
Mar. 19, 2004 (JP) 2004-080312

(51) Int. Cl. G06F 7/00

(52) U.S. Cl. 707/4

(57) ABSTRACT

An area limiting word storing part which stores area limiting words whose meanings limit an area is disposed in a navigation system, and as the area limiting word storing part is referred to, area limiting words are extracted from among keywords, based on the area limiting words, a condition to narrow down a smaller search area is created. A similar word storing part which stores similar words is further disposed, and as the similar word storing part is referred to, similar words to a keyword are extracted and a search condition to expand the range of a search based on the keyword is created. These search conditions together are destination search conditions, in accordance with which a destination information storing part is searched.

### FIELD OF INVENTION

The present invention relates to a mobile body navigation system (called as a navigation system, hereinafter) which provides an automobile or the like which runs on a road with route guidance information and the like to a destination, and to a destination search method and a destination search program for such a navigation system.

In recent years, it has been increasingly becoming popular to use a navigation system which provides, inside an automobile or the like which runs on a road, route guidance information to a destination based on map information held in a DVD (Digital Versatile Disc), an HD (Hard Disk), etc.

When using a navigation system, a user directly designates a location on a map which is displayed on a display screen of the navigation system, thereby setting a destination for route guidance. In the event that the user does not know where the destination is located on the map, the user enters a facility which serves as the destination, the name, the address, the telephone number or the like of a facility which is close to the destination, whereby the destination is set. However, the user does not often know the name, the address, the telephone number or the like of a facility which serves as the destination, and therefore, navigation systems now available on the market are equipped with various types of destination search functions.

When a destination is to be set by using a search function of a navigation system, first, on a display screen of the system, an entry blank for entering information regarding a facility which serves as a destination appears. A user enters information regarding a facility which the user intends as a destination in this entry blank. In response, the navigation system searches a destination facility database which stores information on facilities which can serve as destinations, and lists up those facilities which match with the information entered in the entry blank. The user chooses a destination facility from among the facilities thus listed up, and this facility is set as the destination which requires route guidance.

Since a navigation system is not usually equipped with a key board, a method for entry of information during setting of a destination is that a user selects a destination from among those displayed by the system instead of directly inputting characters. For instance, for the selection of a search area, area names such as “Hokkaido,” “Tohoku” and “Kanto” appear first, and as the user chooses “Kanto” for instance among these, prefecture names such as “Gunma,” “Tochigi” and “Ibaraki” appear next and the user chooses “Ibaraki” for example. Depending on the situation, the name of a municipality is further selected. In this manner, the area to run a search is determined.

In a similar fashion, for entering the type of facility, genres of facilities, e.g., genres such as “Reja (leisure),” “Shoppingu (shopping),” “Resutoran (restaurant)” and “Kokyo Shisetsu (public facility)” appear first, and as the user chooses “Reja (leisure)” for instance from among these, sub-genres such as “Yuenchi (recreation ground),” “Koen (park)” and “Eigakan (movie theater)” further appear. When the user chooses “Eigakan (movie theater)” for example, the navigation system searches the destination facility database, extracts movie theaters within Ibaraki Prefecture for instance, and shows the search result. The user designates the movie theater which is to serve as the destination.

Though the destination setting method above seems to be superior in that the method performs easy determination of a destination, a certain aspect of the method is not superior. For example, when a user wishes to search for a movie theater in Mito, the user must know that “Mito” is in “Kanto” and further in “Ibaraki Prefecture” and which genre “Eigakan (movie theater)” belongs to. When making a wrong selection without that knowledge, the user has to go back to making entries for selection, thus ending up spending unexpected time to set the destination. In addition, the user needs to carefully choose information instructed by the navigation system piece by piece in an instructed order. Such an entry method may be cumbersome or agonizing to the user.

The reference 1 describes an example wherein a keyword is entered and a search for a destination is run. According to that example, a search is run in a database storing information regarding destination facilities based on a keyword entered by a user, and information regarding facilities for which hits are displayed. An area, a facility type or the like is further separately entered, to narrow down facilities. By means of this search method, in accordance with a search condition which is an AND operation of a keyword “Eigakan (movie theater)” and a keyword which is the title of a movie such as “ABC no Bouken” (Adventure of ABC) for instance, a destination search is conducted.

Additionally, the reference 2 describes an example wherein during a search using a keyword, the keyword is expanded even to words which are associated with the keyword. The reference 2 further describes that for instance, even ceramic making lessons and flower arrangement lessons can be covered in a search based on a keyword “Karucha Senta (cultural activities center).” This prevents an inaccurate search even when a proper keyword is not available for a destination search.

Reference 1:

Paragraphs 0030 through 0040 and FIGS. 5 and 6, Japanese Laid-Open Application 2001-194162

Reference 2:

Paragraphs 0006 through 0008, Paragraphs 0039 through 0054 and FIGS. 2 and 3, Japanese Laid-Open Application 2002-297028

However, each one of the reference 1 and the reference 2 uses both a search based on a keyword and a search based on selection and designation of a genre. In this case, while a user can freely enter a keyword, the user has to choose an area, a genre and the like in accordance with items displayed by the system when narrowing down search results based on the keyword, which is similar to the conventional technique described earlier. This entry/operation method therefore is merely a conventional method as it additionally includes an operation of entering a keyword.

### SUMMARY OF THE INVENTION

An object of the present invention is to realize a navigation system which permits a user search for a destination based on a keyword freely entered by the user instead of demanding the user make a complicated entry operation in accordance with instruction information.

The reason the conventional technique uses both the two entry methods above is because there are no means which determine whether an entered keyword is a word which limits a search area and the search area therefore cannot be limited. Consequently, a navigation system according to the present invention comprises an area limiting word storing means which stores area limiting words whose meanings limits areas, as the area limiting word storing means is referred to, whether an entered keyword is an area limiting word is determined, and when the entered keyword is an area limiting word, a search area is limited based on the area limiting word.

In short, the navigation system according to the present invention is a navigation system which comprises: location information entry means for entering current location information of a mobile body; a keyword entry means for entering a keyword which is for searching for a destination which the mobile body heads to; area limiting word storing means for storing area limiting words whose meanings limit areas; area limiting word extracting means which extracts area limiting words while referring to the area limiting word storing means as for a keyword entered through the keyword entry means; destination information storing means in which for each destination, geographic information and other attribute information regarding the destination is stored; a destination search condition creating means which creates a search condition to search the destination information storing means based on the current location information entered through the location information entry means, the keyword entered through the keyword entry means and the area limiting words extracted by the area limiting word extracting means; destination searching means which searches the destination information storing means based on the search condition created by the destination search condition creating means; and a destination search result outputting means which displays the result of the search conducted by the destination searching means.

The present invention is directed also to a destination search method according to which area limiting words are extracted with reference to the area limiting word storing means among keywords entered by a user, an area search condition which is in line with the area limiting words is created and a search condition is created based on the keywords entered earlier, and a destination search is run.

By means of the navigation system and the destination search method having such structures above, area limiting words which limit a search target area can be extracted from among keywords entered by a user, and an area search condition can be set based on the area limiting words. The navigation system thus does not need to show area names and other items which are allowed to be chosen by the user, and the user does not have to choose a search area and the like in accordance with displayed instructions.

The present invention is directed also to a navigation system which further comprises similar word storing means which stores in advance similar words to those words which can be entered as keywords and similar word extracting means which extracts similar words to entered keywords while referring to the similar word storing means. The present invention is further directed to a destination search method for use in a navigation system having this structure, according to which the similar word extracting means, while referring to the similar word storing means in relation to an entered keyword, extracts similar words to the keyword and the destination searching means runs a destination search using the entered keyword and the similar words to the keyword.

When using the navigation system and the destination search method having such structures, a user can freely enter keywords as soon as he or she thinks of the keywords regardless of whether the words entered as the keywords are proper or not. For example, as long as the user enters “Mito, Eigakan (movie theater), “the navigation system searches for movie theaters in or adjacent to Mito. The user does not have to know whether “Mito” is in Kanto or Ibaraki Prefecture and the user does not need to be concerned which genre “Eigakan (movie theater)” belongs to. The user is thus under less psychological stress when using the navigation system.

As described above, according to the present invention, a user of the navigation system can freely enter keywords to search for a destination which requires route guidance, independently in the order of entering the keywords and whether the entered words are proper.

### BRIEF DESCRIPTION OF DRAWINGS

FIG. 1 is a schematic showing an example of a functional structure of a navigation system according to a first embodiment of the present invention;

FIG. 2 is a schematic showing an example of a hardware structure of the navigation system according to the first embodiment of the present invention;

FIG. 3 is a schematic showing the outline of the procedure of a destination search according to the first embodiment of the present invention;

FIG. 4 is a schematic showing an example regarding how a keyword entry program for entering a keyword proceeds according to the first embodiment of the present invention;

FIG. 5 is a schematic showing an example of a display screen displayed by a display apparatus in accordance with the keyword entry program according to the first embodiment of the present invention;

FIG. 6 is a schematic of entered word areas and similar word areas created in a main storage device according to the first embodiment of the present invention;

FIG. 7 is a schematic showing an example of a data structure within a similar word storing part created in a disk storage device according to the first embodiment of the present invention;

FIG. 8 is a schematic showing an example regarding how a similar word extracting program proceeds according to the first embodiment of the present invention;

FIG. 9 is a schematic showing an example of a data structure within an area limiting word storing part created in the disk storage device according to the first embodiment of the present invention;

FIG. 10 is a schematic showing an example regarding how an area search condition extracting program proceeds according to the first embodiment of the present invention;

FIG. 11 shows an example of destination search conditions created in accordance with a destination search condition creating program according to the first embodiment of the present invention;

FIG. 12 shows an example of a destination information record stored in a destination information storing part according to the first embodiment of the present invention;

FIG. 13 is a schematic showing an example regarding how a destination search program proceeds according to the first embodiment of the present invention;

FIG. 14 is a schematic showing an example of a display apparatus displaying the result of a destination search according to the first embodiment of the present invention; and

FIG. 15 is a schematic showing an example of a functional structure of a navigation system according to a second embodiment of the present invention.

### DETAILED DISCRIPTION OF THE INVENTION

### First Embodiment

A first embodiment of the present invention will now be described in detail with reference to the related drawings.

((Structure of Navigation System))

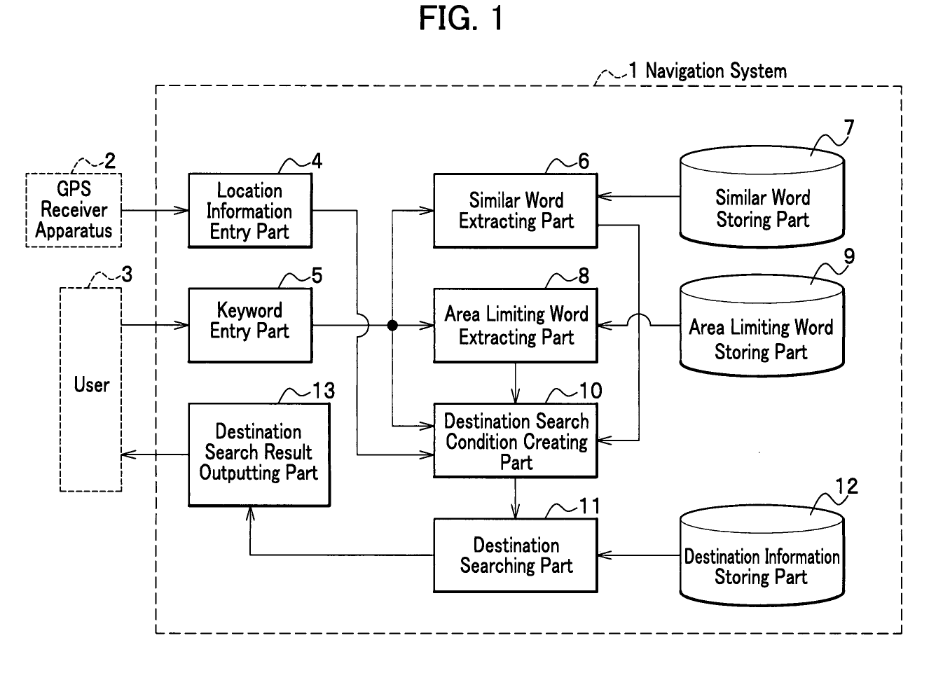

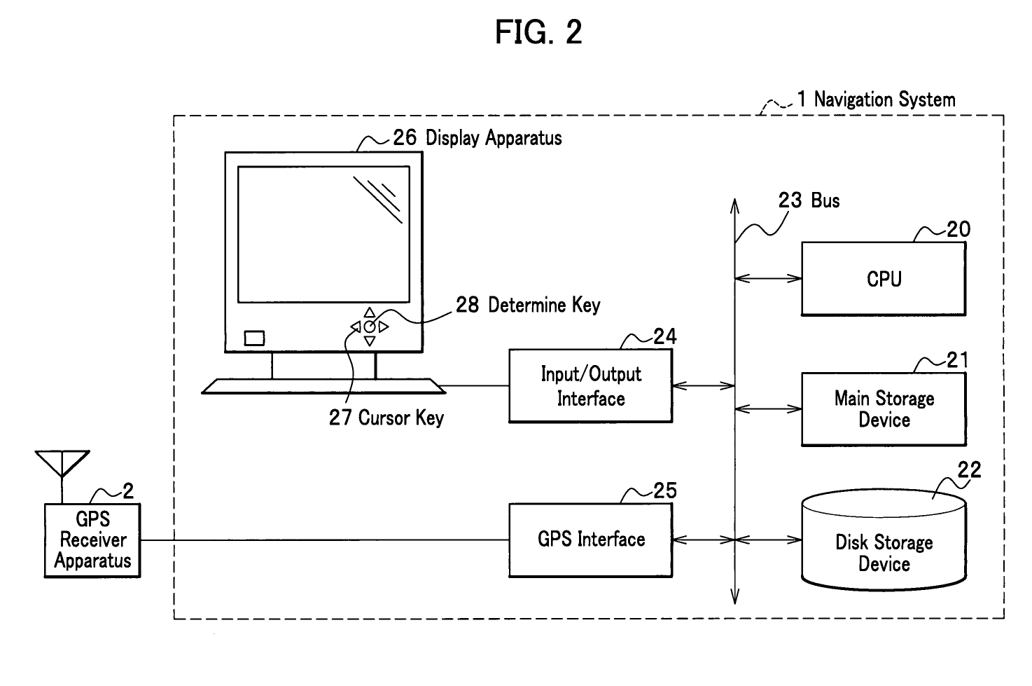

FIG. 1 is a schematic which shows an example of a functional structure of the navigation system according to the first embodiment of the present invention, and FIG. 2 is a schematic which shows an example of a hardware structure of the navigation system according to the first embodiment of the present invention.

As shown in FIG. 1, the navigation system 1 according to the first embodiment has a structure which is comprised of a location information entry part 4 which is a location information entry means, a keyword entry part 5 which is a keyword entry means, a similar word storing part 7 which is a similar word storing means, a similar word extracting part 6 which is a similar word extracting means, an area limiting word storing part 9 which is an area limiting word storing means, an area limiting word extracting part 8 which is an area limiting word extracting means, a destination information storing part 12 which is a destination information storing means, a destination search condition creating part 10 which is a destination search condition creating means, a destination searching part 11 which is a destination searching means, and a destination search result outputting part 13 which is a destination search result outputting means. The navigation system 1 having such a structure is usually mounted to an automobile or the like which is a mobile body to which route guidance should be subjected. The mobile body is usually equipped with a GPS (Global Positioning System) receiver apparatus 2 which is for sensing the current location of the mobile body.

In FIG. 1, the location information entry part 4 accepts entry of the current location information output from the GPS receiver apparatus 2, and sends the current location information to the destination search condition creating part 10. The keyword entry part 5 accepts entry of keywords keyed in or otherwise entered by a user 3, and sends thus entered keywords to the similar word extracting part 6, the area limiting word extracting part 8, the destination search condition creating part 10, etc. Further, based on the keywords thus sent, the similar word extracting part 6 searches the similar word storing part 7 which stores in advance the similar words to words which can serve as keywords, and for each keyword thus sent, extracts similar words for each keyword which has been sent. Further, based on the keywords thus sent, the area limiting word extracting part 8 searches the area limiting word storing part 9 which stores in advance area limiting words whose meanings limit areas, and extracts area limiting words among the keywords.

Next, the destination search condition creating part 10 creates a search condition to search the destination information storing part 12, based on the current location information sent from the location information entry part 4, the keywords sent from the keyword entry part 5, the similar words to the keywords extracted by the similar word extracting part 6 and the area limiting words extracted by the area limiting word extracting part 8. The destination searching part 11 searches the destination information storing part 12 in accordance with the search condition created by the destination search condition creating part 10. The destination search result outputting part 13 makes a display apparatus 26 (See FIG. 2.) formed by an LCD (Liquid Crystal Display) and the like show the result of the search run by the destination searching part 11.

As shown in FIG. 2, the navigation system 1 according to the first embodiment is in the form of a computer and comprised of a CPU (Central Processing Unit) 20 which executes information processing such as logic operation, etc., a main storage device 21 formed by a semiconductor memory and the like, a disk storage device 22 formed by an HD (Hard Disk), a DVD (Digital Versatile Disk), etc., a bus 23 which links these, the display apparatus 26 which displays data such as characters, images and graphics in accordance with an instruction given by the CPU 20, a cursor key 27 which shifts a cursor which is displayed on the display apparatus 26, a determine key 28 which instructs reading of information displayed at the location of the cursor key, an input/output interface 24 which links the display apparatus 26, the cursor key 27, the determine key 28 and the like to the bus 23, and a GPS interface 25 which links the GPS receiver apparatus 2 to the bus 23. The disk storage device 22 may be replaced with a non-volatile semiconductor memory, such as a flash memory, which can be electrically rewritten.

In FIG. 1, the similar word storing part 7, the area limiting word storing part 9 and the destination information storing part 12 are an aggregation of information held in the disk storage device 22. Further, in FIG. 1, the similar word extracting part 6, the area limiting word extracting part 8, the destination search condition creating part 10 and the destination searching part 11 are a program and stored in the main storage device 21. The location information entry part 4 shown in FIG. 1 is comprised of the GPS interface 25 and a program for entering current location information sent from the GPS receiver apparatus 2 via the GPS interface 25. Further, the keyword entry part 5 shown in FIG. 1 is comprised of hardware, which includes the display apparatus 26, the cursor key 27, the determine key 28 and the input/output interface 24, and a program for entering keywords through the hardware. The destination search result outputting part 13 shown in FIG. 1 is comprised of hardware including the display apparatus 26 and a program for making the display apparatus 26 show the result of a destination search obtained as a result of execution of the program of the destination searching part 11.

The programs in the structure above are usually stored in the main storage device 21 and executed by the CPU 20. However, in the event that the main storage device 21 is formed by a volatile semiconductor memory, the programs are usually stored in the disk storage device 22 or a ROM (Read Only Memory) not shown, and when the navigation system 1 is turned on or at the time of execution of the programs, the programs are read from the disk storage device 22 or the ROM to the main storage device 21 and the CPU 20 executes the programs.

((Procedure of Destination Search in Navigation System))

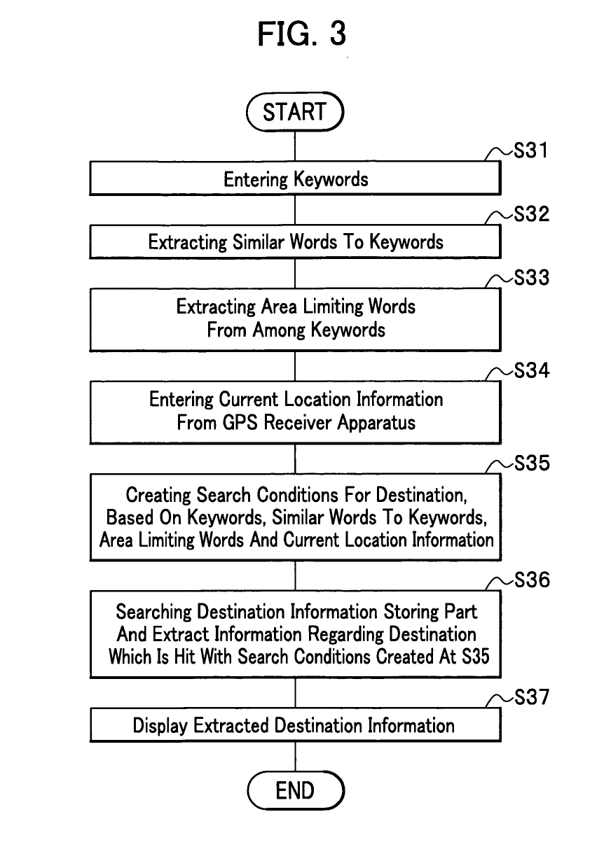

The procedure of a destination search in the navigation system 1 will now be described in detail with reference to FIGS. 3 through 14 and when appropriate FIGS. 1 and 2.

(0. Outline of Procedure)

First, FIG. 3 is a schematic which shows the outline of the procedure of a destination search according to the first embodiment of the present invention. A destination search is initiated as the user 3 keys in a keyword. First, the navigation system 1 reads the characters keyed in by the user 3, whereby the keyword is entered (S31). Next, with reference to the similar word storing part 7 as for the thus entered keyword, similar words to the keyword are extracted (S32), and with reference to the area limiting word storing part 9 as for the entered keyword, area limiting words for the keyword are extracted (S33). Further, the current location information is entered from the GPS receiver apparatus 2 (S34).

Next, based on the keyword, the similar words to the keyword, the area limiting words and the current location information entered or extracted in this manner, a destination search condition is created (S35). Based on the thus created destination search condition, a search is run in the destination information storing part 12, information regarding destinations which hits the destination search condition is extracted (S36), and the display apparatus 26 displays the extracted destination information (S37).

In the procedure above, the step S32, the step S33 and the step S34 may be executed in an altered order.

(1. Processing in Keyword Entry Part 5)

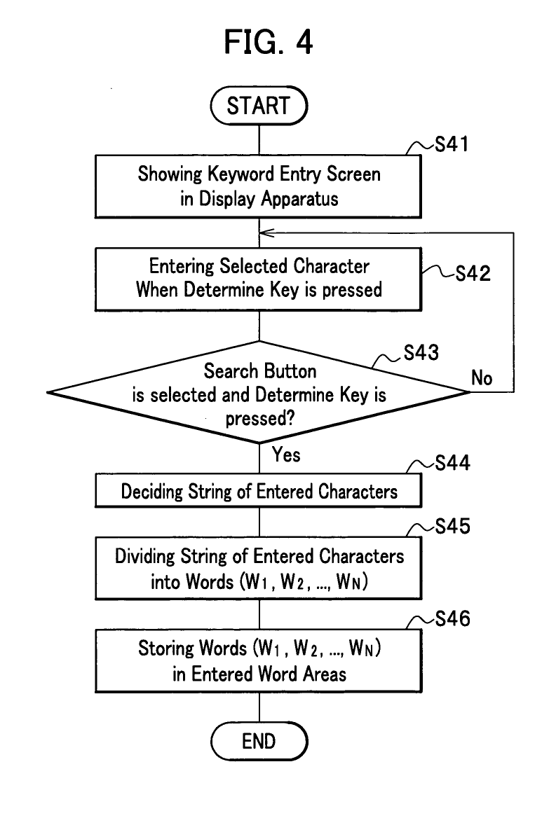

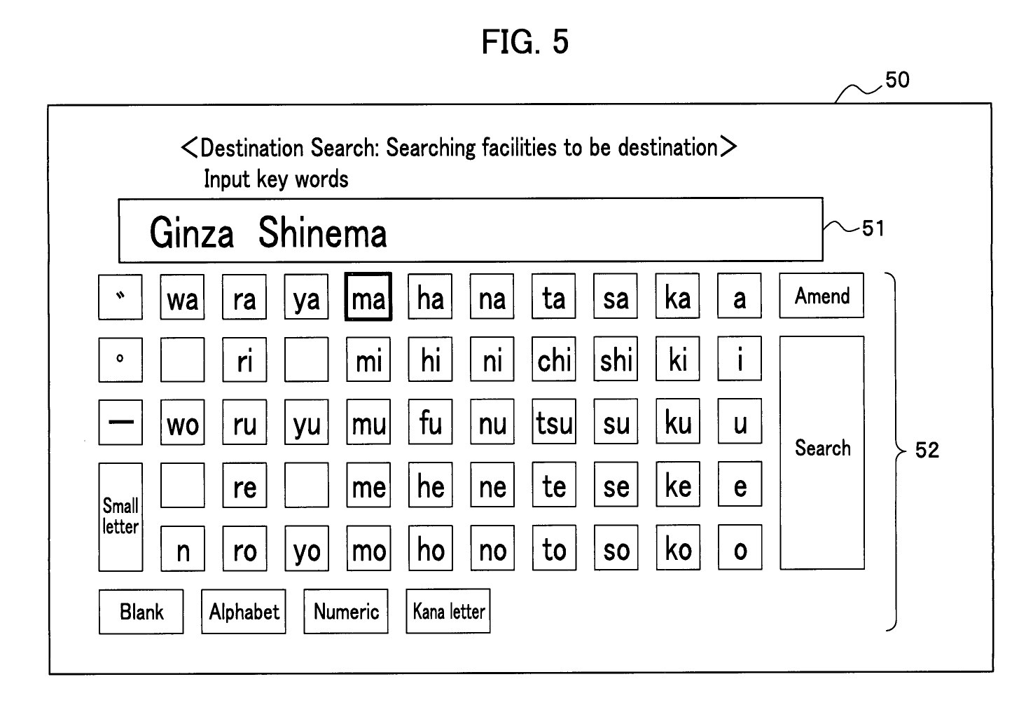

FIG. 4 is a schematic which shows an example regarding how a keyword entry program for entering a keyword proceeds according to the first embodiment of the present invention. FIG. 5 is a schematic which shows an example of a display screen displayed by the display apparatus in accordance with the keyword entry program. The keyword entry program is processing for configuring the keyword entry part 5, fetching a keyword entered by the user 3 to the CPU 20 and storing the same in a predetermined region within the main storage device 21. In this embodiment, the navigation system 1 comprises only the cursor key 27 and the determine key 28 as entry keys as shown in FIG. 2 but does not comprise a hardware keyboard.

In FIG. 4, first, the navigation system 1 shows in its display apparatus 26 a keyword entry screen 50 as that shown in FIG. 5 (S41) Appearing in the keyword entry screen 50 are a keyword display area 51 where characters entered as a keyword are shown and a software keyboard 52 which is for entering characters. On the software keyboard 52, the user 3 moves the cursor, using the cursor key 27, toward the left, the right, above and below and chooses a character to enter. The cursor referred to here is only one key button of the software keyboard 52, namely, a key button which is displayed in remarked bold, blinking or otherwise distinctive ones from other key buttons. By means of this cursor, the user 3 can choose a character to enter.

Next, the user 3 presses the determine key 28 and the navigation system 1 reads the character. In other words, in accordance with the keyword entry program, when the determine key 28 is pressed, the character selected at the cursor is entered (S42), and the thus entered character is displayed in the keyword display area 51. During this entry processing, a search button is chosen at the cursor and whether the determine key 28 is pressed is judged (S43), and when the judgment is negative (“No” at S43), entry of a character (S42) is repeated.

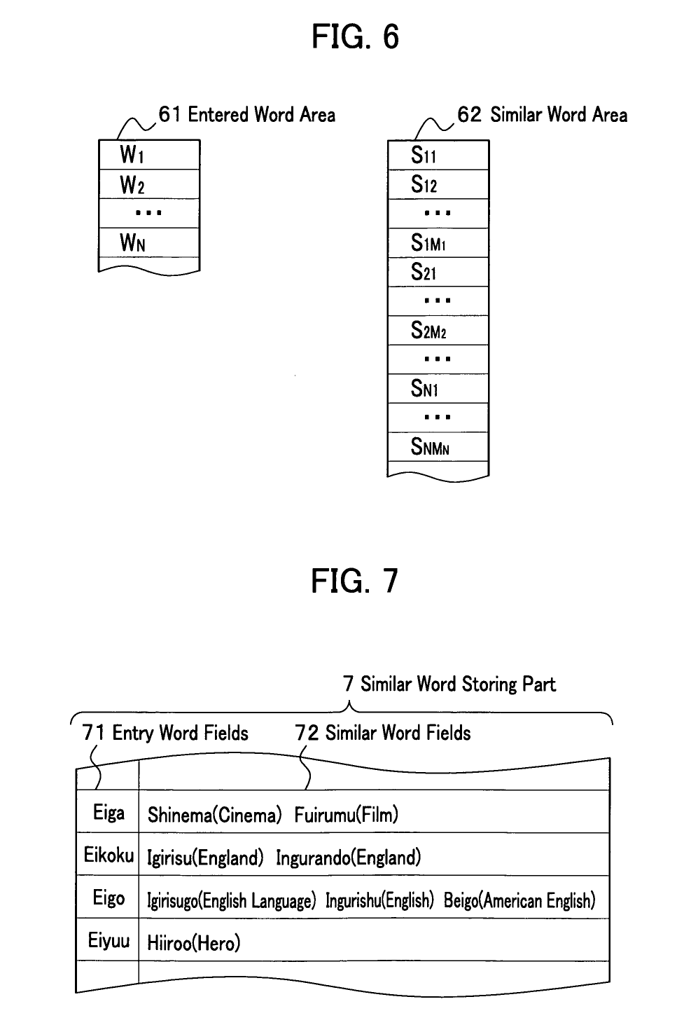

On the contrary, when the search button is selected and it is determined that the determine key 28 is pressed (“Yes” at S43), assuming that entry of a keyword is complete, a string of characters entered as a keyword is decided (S44). The string of the entered characters is divided into N pieces of words (W₁, W₂, . . . , W_{N}) (S45), and the words (W₁, W₂, . . . , W_{N}) are stored in entered word areas 61 (See FIG. 6 which will be described later) (S46). While particles may be used as delimiter characters for words when the string of the entered characters is divided into the words, for simplicity of description, blanks are used as delimiter characters in the description below.

(2. Processing in Similar Word Extracting Part 6)

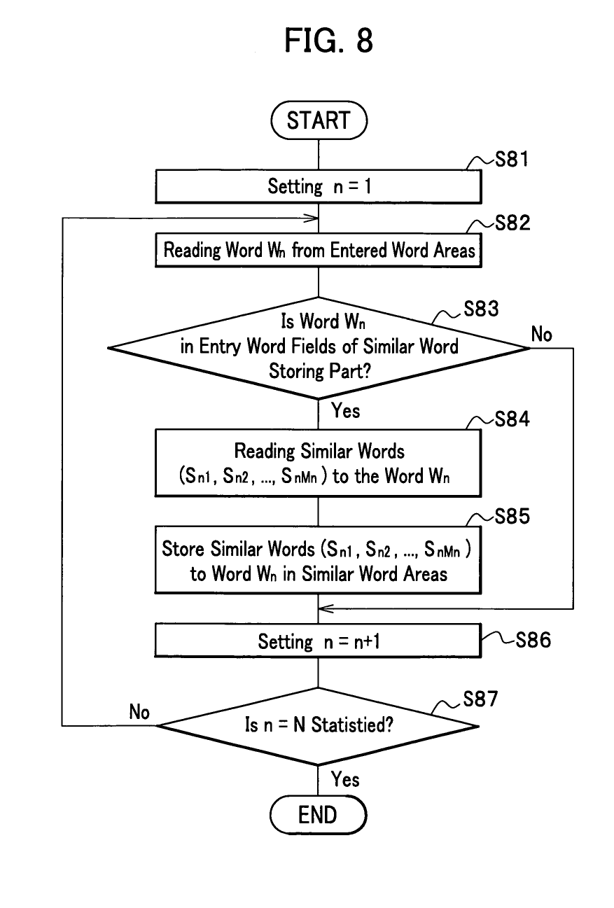

A similar word extracting program which forms the similar word extracting part 6 will now be described with reference to FIGS. 6 through 8. FIG. 6 is a schematic showing the entered word areas and the similar word areas created in the main storage device according to the first embodiment, FIG. 7 is a schematic which shows an example of a data structure within the similar word storing part created in the disk storage device 22 according to the first embodiment, and FIG. 8 is a schematic which shows an example regarding how the similar word extracting program proceeds according to the first embodiment.

The entered word areas 61 and the similar word areas 62 in FIG. 6 are temporary storage regions created in the main storage device 21 (See FIG. 2.). In the entered word areas 61, words entered as keywords are stored in accordance with the keyword entry program. Shown in FIG. 6 is an example wherein the N pieces of words (W₁, W₂, . . . , W_{N}) are stored. Additionally, in the similar word areas 62, similar words extracted in accordance with the similar word extracting program are stored.

The similar word storing part 7 shown in FIG. 7 (See FIG. 1.) is formed by entry word fields 71 in which words which can be entered as keywords and similar word fields 72 in which similar words to each entry word are stored. In FIG. 7, “Eiga (movies)” is stored in the entry word fields 71 and as similar words to this entry word, “Shinema (cinema)” and “Firumu (film)” are stored in the similar word fields 72. Entry words and similar words to the entry words to be stored in the similar word storing part 7 are determined in advance, and stored in the disk storage device 22 (See FIG. 2.) while the system is being constructed.

The similar word extracting program shown in FIG. 8 is initiated as the keyword entry program shown in FIG. 4 ends. First, as initialization, a counter n is set as 1 (S81). Following this, a word Wₙ is read from the entered word areas 61 (S82). Next, whether the thus read word Wₙ is within the entry word fields 71 of the similar word storing part 7 is determined (S83). When it is found as a result that the word Wₙ is within the entry word fields 71 of the similar word storing part 7 (“Yes” at S83), similar words (Sₙ₁, Sₙ₂, . . . , S_{nMn}) to the word Wₙ are read while referring to the similar word field 72 which corresponds to this entry word, i.e., the word Wₙ (S84) The similar words (Sₙ₁, Sₙ₂, . . . , S_{nMn}) to the word Wₙ thus read are then stored in the similar word areas 62 (S85). On the contrary, when the word Wₙ is not within the entry word fields 71 of the similar word storing part 7 (“No” at S83), the processing at the step S84 and the step S85 is skipped.

In FIG. 8, the counter n is then incremented to n=n+1 (S86), and whether n has reached the number N of the entered keywords, that is, whether n=N holds is determined (S87) In the event that n has not yet reached N, that is, when n=N does not hold (“No” at S87), the processing at step S82 through step S87 is repeated after returning to step S82. On the contrary, in the event that n has reached N, that is, when n=N holds (“Yes” at S87), the processing according to the similar word extracting program ends. At the end of the similar word extracting program, similar words S₁₁, S₁₂, . . . , S_{1M1} to the word W₁, similar words S₂₁, S₂₂, . . . , S_{2M2} to the word W₂ and similar words S_{N1}, S_{N2}, . . . , S_{NMN} to the word W_{N} are stored in the similar word areas 62 (See FIG. 6.).

(3. Processing in Area Limiting Word Extracting Part 8)

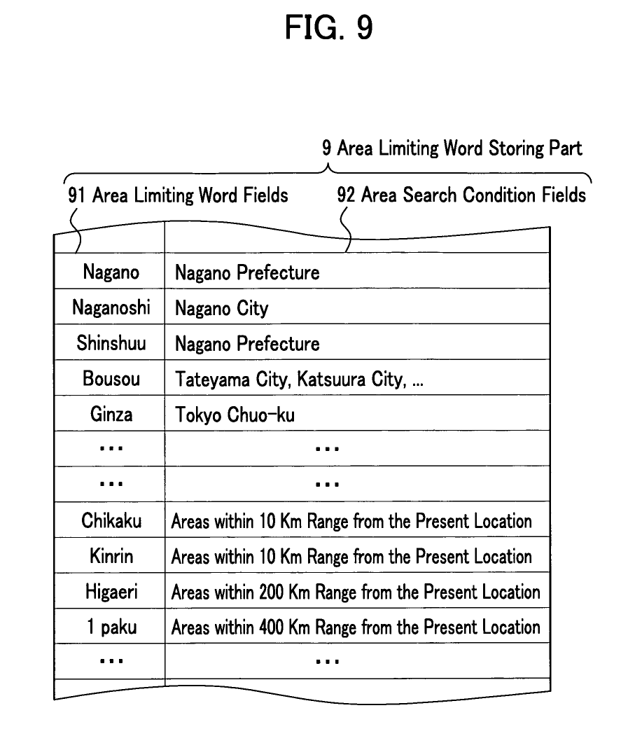

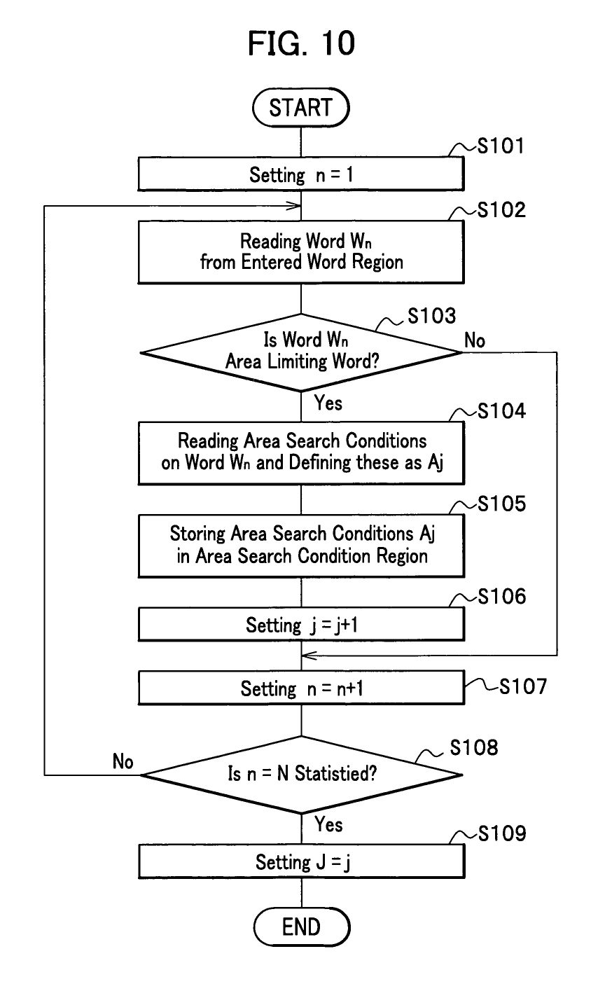

An area search condition extracting program which forms the area limiting word extracting part 8 will now be described with reference to FIGS. 9 and 10. FIG. 9 is a schematic which shows an example of a data structure within the area limiting word storing part created in the disk storage device 22 according to the first embodiment, and FIG. 10 is a schematic which shows an example regarding how the area search condition extracting program proceeds according to the first embodiment.

In FIG. 9, the area limiting word storing part 9 (See FIG. 1) includes area limiting word fields 91 and area search condition fields 92. Area limiting words whose meanings limit areas are stored in the area limiting word fields 91, while area search conditions corresponding to the area limiting words are stored in the area search condition fields 92. Area limiting words referred to here are place names or region names or those words which limit areas relative to the current location such as “adjacent to,” “neighborhood” and “day trip.” Area search conditions are conditions for limiting the ranges of areas inside which destinations are to be searched for.

In this embodiment, in the event that place names or region names are area limiting words, the names of prefectures or municipalities directly appear in the area search condition fields 92. For instance, when one area limiting word field 91 is “Boso,” as area search conditions, the names of municipalities on the Boso peninsula are described as “Tateyama, Katsuura, . . . ” on the area search condition fields 92. Additionally, in the event that area limiting words are the words which limit areas in a relative manner, as conditions regarding the ranges of search areas are described as “an area at or within 10 Km from the current location” for “adjacent to” and “an area at or within 20 Km from the current location” for “day trip,” for example, in the area search condition fields 92.

The area limiting words and the area search conditions to be stored in the area limiting word storing part 9 are determined in advance and stored in the disk storage device 22 (See FIG. 2.) while the system is being constructed.

The area search condition extracting program shown in FIG. 10 is a program for extracting the area limiting words from among the words (W₁, W₂, . . . , W_{N}) entered as keywords and further extracting the area search conditions which are stored in association with these area limiting words. Hence, these program functions as the area limiting word extracting part 8 which is shown in FIG. 1 and also partially as the destination search condition creating part 10.

In FIG. 10, the area search condition extracting program first requires initialization of the counter n which counts the number of words entered as keywords and a counter j which counts the number of the area limiting words, whereby n=1 and j=1 hold (S101). Next, from the entered word areas 61 in which the entered keywords are stored, the word Wₙ is read (S102). With reference to the area limiting word fields 91 of the area limiting word storing part 9, whether the word Wₙ is an area limiting word or not is determined (S103). When the word Wₙ is consequently found as an area limiting word (“Yes” at S103), with reference to the area search condition fields 92 of the area limiting word storing part 9, the area limiting words, namely, the area search conditions corresponding to the word Wₙ are read and set as Aⱼ (S104). Thus the read area search conditions Aᵢ are then stored in an area search condition region. The area search condition region is a storage region not shown stored in the main storage device 21. Next, the counter j is incremented to j=j+1 (S106) and the counter n is incremented to n=n+1 (S107). On the contrary, in the event that the word Wₙ is not an area limiting word (“No” at S103), the processing at step S104 and step S105 is skipped and the sequence proceeds to the processing at step S107.

In FIG. 10, whether a determination regarding whether each word Wₙ is an area limiting word is finished for all words Wₙ, that is, whether n=N holds is determined (S108). When a result is found that n=N does not hold (“Yes” at S108), the processing at step S102 through step S107 is repeated after returning to step S102. On the contrary, when n=N holds (“Yes” at S108), it is determined that J=j (S109), the number of the area limiting words contained in the entered keywords is stored as J, and the processing according to the area search condition extracting program ends.

(4. Processing in Destination Search Condition Creating Part 10)

A destination search condition creating program which forms the destination search condition creating part 10 will now be described. By means of the keyword entry program, the similar word extracting program and the area search condition extracting program described respectively in relation to FIGS. 4, 8 and 10, the words (W₁, W₂, . . . , W_{N}) entered as keywords, the similar words to these words (S₁₁, S₁₂, . . . , S_{1M1}, S₂₁, S₂₂, . . . , S_{2M2}, S_{N1}, S_{N2}, . . . , S_{NMN}) and the area search conditions (A₁, A₂, . . . , A_{J}) are obtained. Next, the destination search condition creating program creates a destination search condition which is for searching the destination information storing part 12 in accordance with these words, the similar words and the area search conditions.

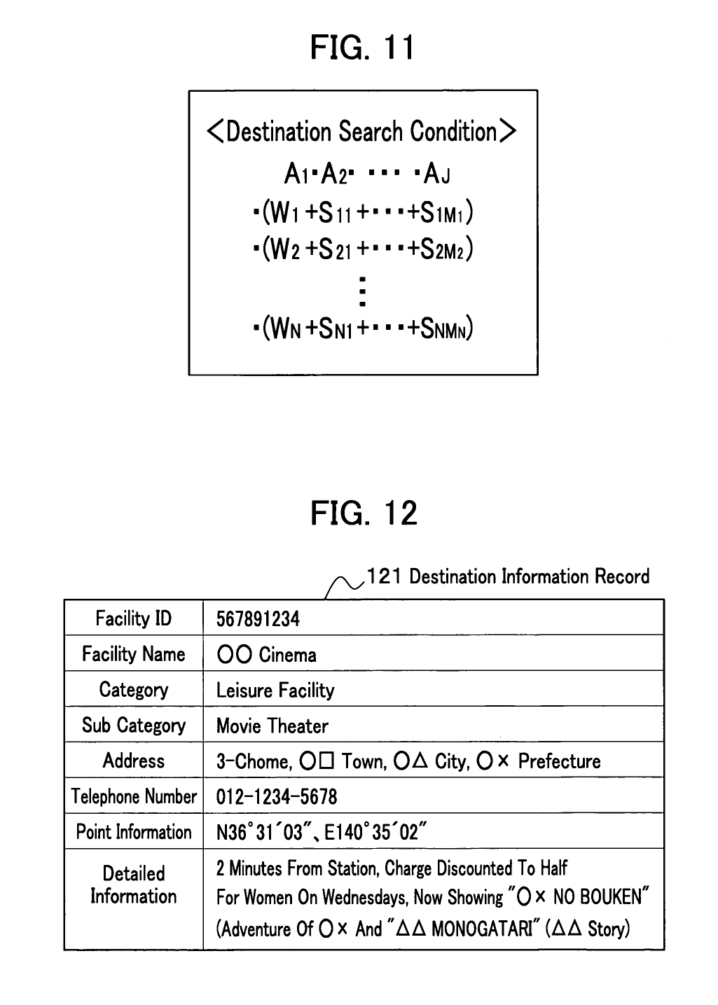

FIG. 11 shows an example of destination search conditions created in accordance with the destination search condition creating program (The flow of the processing is not shown.) according to the first embodiment. In this example, the symbol Aⱼ (j=1, . . . , J) is indicative of a search for a destination which is located within an area designated by the area search condition Aᵢ, and the symbols Wₙ and S_{nMn} (n=1, . . . , N) is indicative of a search regarding whether a word Wₙ or a similar word S_{nMnN} is contained in information stored in the destination information storing part 12. Further, the symbol “▪” denotes AND operation, while the symbol “+” denotes OR.

Hence, the destination search conditions shown in FIG. 11 are indicative of a search for a destination which is located within an area satisfying all area search conditions Aᵢ (j=1, . . . , J) and regarding which destination information storing part 12 contains the word W₁ or any one of its similar words S₁₁, S₁₂, . . . , S_{1M1}, the word W₂ or any one of its similar words S₂₁, S₂₂, . . . , S_{2M2} and the word W_{N} or any one of its similar words S_{N1}, S_{N2}, . . . , S_{NMN}.

It is assumed, for example, that W₁=“Shinema (cinema),” W₂=“Ginza” and W₃=“Tokyo” are entered as keywords, as for “Shinema (cinema),” its similar words S₁₁=“Eiga (movies)” and S₁₂=“Firumu (film)” are extracted and further A₂=“Tokyoto Chuoku Ibaraki Prefecture |x-shi, Chiba Prefecture |-shi” and A₃=“Tokyo” are extracted as area search conditions. In this example, since AND (A₂▪A₃) of the area search conditions with respect to area search conditions, “Ibaraki Prefecture |x-shi and Chiba Prefecture HH-shi” are excluded from the area search conditions, leaving only “Chuo-ku in Tokyo.” Hence, the overall search condition is to search for a destination (facility) which is located in Chuo-ku, Tokyo and regarding which destination information storing part 12 contains “Shinema (cinema),” “Eiga (movies)” or “Firumu (film)” and contains “Ginza” and “Tokyo.”

In the event that an area search condition is expressed referring to a relative distance, reading “at or within 200 km from the current location” for instance, according to the destination search condition creating program of the destination search condition creating part 10, current location information entered via the location information entry part 4 is read, the names of municipalities at or within 200 km from the current location, for example, are identified based on the current location information and map data (not shown) stored in the disk storage device 22, and these are defined as area search conditions.

FIG. 12 shows an example of a destination information record stored in the destination information storing part according to the first embodiment. In this example, a destination information record 121 is comprised of a facility ID, a facility name, a category, a sub category, an address, a telephone number, point information and detailed information but may include other items. The detailed information is the data freely describing a feature, a selling point and the like of the facility. The destination information record 121 is not different from map data and therefore may form a part of map data.

(5. Processing in Destination Search Part 11)

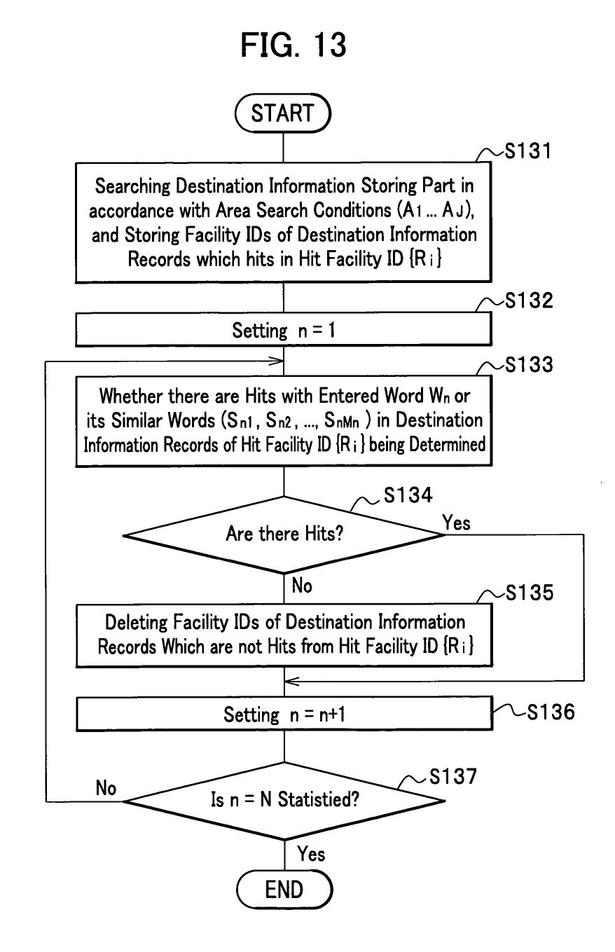

A destination search program which forms the destination search part 11 will now be described. FIG. 13 is a schematic which shows an example regarding how the destination search program proceeds according to the first embodiment. The destination search program is a program for configuring the destination search part 11, searching the destination information storing part 12 in accordance with the destination search conditions shown in FIG. 11 and extracting the destination information record 121 which satisfies the destination search conditions. In this example, however, only the facility ID in the destination information record 121 is extracted.

In FIG. 13, according to the destination search program, first, a search is run in the destination information storing part 12 in accordance with area search conditions (A₁, A₂, . . . , A_{J}) and the facility IDs in the destination information records 121 which hits (which fits to) the area search conditions that are stored in a hit facility ID {Rᵢ} (S131). That is, during this processing, the destination information records 121 regarding areas designated by the area search conditions, e.g., destinations located in “Tokyoto Chuo-ku” are extracted, of which Rᵢ, namely, the facility IDs are stored in the hit facility ID {Rᵢ}. The hit facility ID {Rᵢ} is a storage region allocated in a predetermined region within the main storage device 21.

Next, the counter n for a keyword count is initialized to n=1 (S132). The destination information records 121 in the hit facility ID {Rᵢ} are then searched, and whether there is a hit with a word Wₙ entered as a keyword or its similar words (Sₙ₁, Sₙ₂, . . . , S_{nMn}) in the destination information records 121 is determined (S133). When it is a result that there is no hit (“No” at S134), the facility IDs of the destination information records 121 which are hit are deleted from the hit facility ID {Rᵢ} (S135). When a keyword is “Shinema (cinema)” and its similar words are “Eiga (movies)” and “Firumu (film)” for instance, the facility IDs of the destination information records 121 which do not contain “Shinema (cinema), ” “Eiga (movies)” or “Firumu (film)” within the destination information records 121 are deleted from the hit facility ID {Rᵢ}. On the contrary, in the event that hits are found as a result of the judgment made at step S133 (“Yes” at S134), the processing at step S135 is skipped.

Following this, the counter n is incremented to n=n+1 (S136). Whether the counter n for a keyword count has reached the number N of the entered keywords, that is, whether n=N holds is determined (S137). When n=N does not hold yet (“No” at S137), the processing at step S133 through step S137 is executed repeatedly. When n=N has been satisfied (“Yes” at S137), the processing according to the destination search program ends. The hit facility ID {Rᵢ} at the end of the destination search program is nothing other than a result of a search of the destination information storing part 12 in accordance with the destination search conditions shown in FIG.

(6. Processing in Destination Search Result Outputting Part 13)

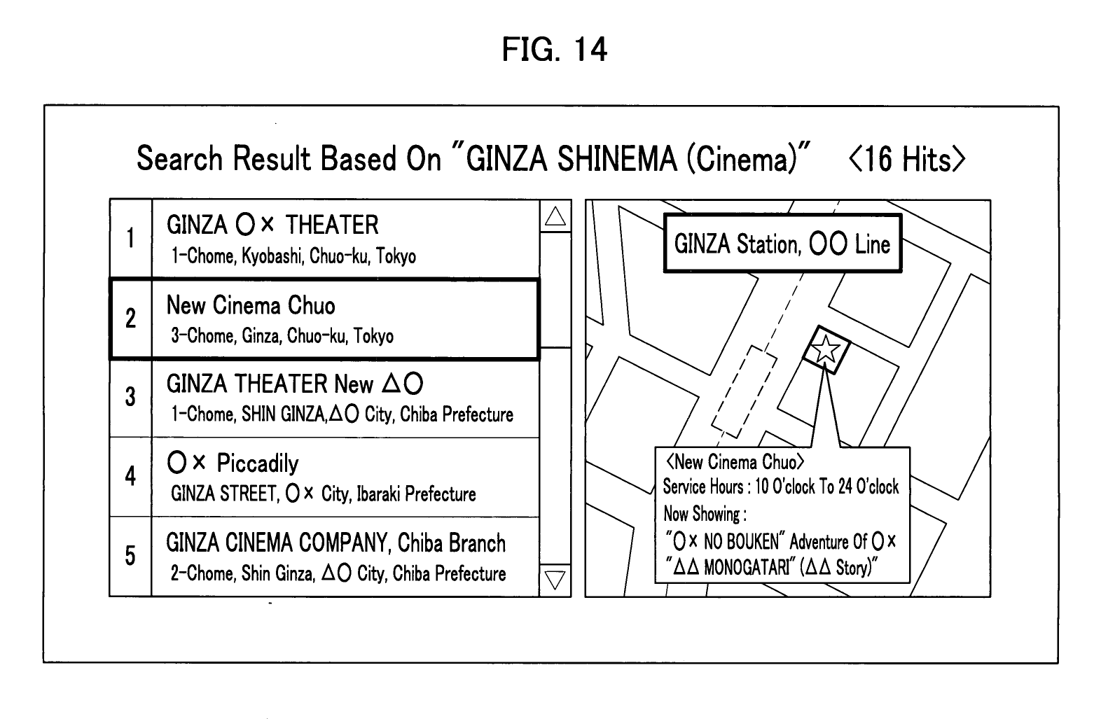

A destination search result outputting program which forms the destination search result outputting part 13 will now be described. The destination search result outputting program is displayed on the display apparatus 26 (See FIG. 2.) which shows the contents of the destination information records 121 whose facility IDs are contained in the hit facility ID {Rᵢ}. FIG. 14 is a schematic which shows an example of the display apparatus 26 displaying the result of a destination search according to the first embodiment. In FIG. 14, shown on the left-hand side is a list of the names and addresses of facilities which have the extracted facility IDs, while shown on the right-hand side is a location adjacent map and detailed information regarding the address of a facility selected by the user 3 from the list of the names and addresses of facilities.

For instance, FIG. 14 shows an example of the result of an area search for which “Ginza Shinema (cinema)” is entered as keywords. As for facilities under the search, municipalities containing “Ginza” are extracted in accordance with the area search condition “Ginza,” and further, those for which the destination information records 121 contain “Ginza” and “Shinema (cinema),” “Eiga (movies)” or “Firumu (film)” are extracted. In this case, since the keyword does not contain “Tokyo,” Ginza in Ibaraki Prefecture and that in Chiba Prefecture are also extracted.

Various formats may be set for a method of displaying a search result: For instance, the map adjacent to the selected facility and the detailed information on the right-hand side of the screen shown in FIG. 14 may be displayed inside a pop-up window. The facility list on the left-hand side may show a part of the detailed information, instead of including the names and addresses of facilities alone.

As described above, according to the first embodiment of the present invention, area limiting words are extracted from among keywords freely entered by the user 3 with reference to the area limiting word storing part 9 which stores area limiting words in advance, and based on these area limiting words, an area search condition can be set. Further, with respect to the entered keywords, since similar words to the keywords are also covered by a search by means of OR, it is not necessary to enter many keywords. The user can therefore enter any keyword freely and naturally as he or she thinks of the keyword when searching for a destination.

### Second Embodiment

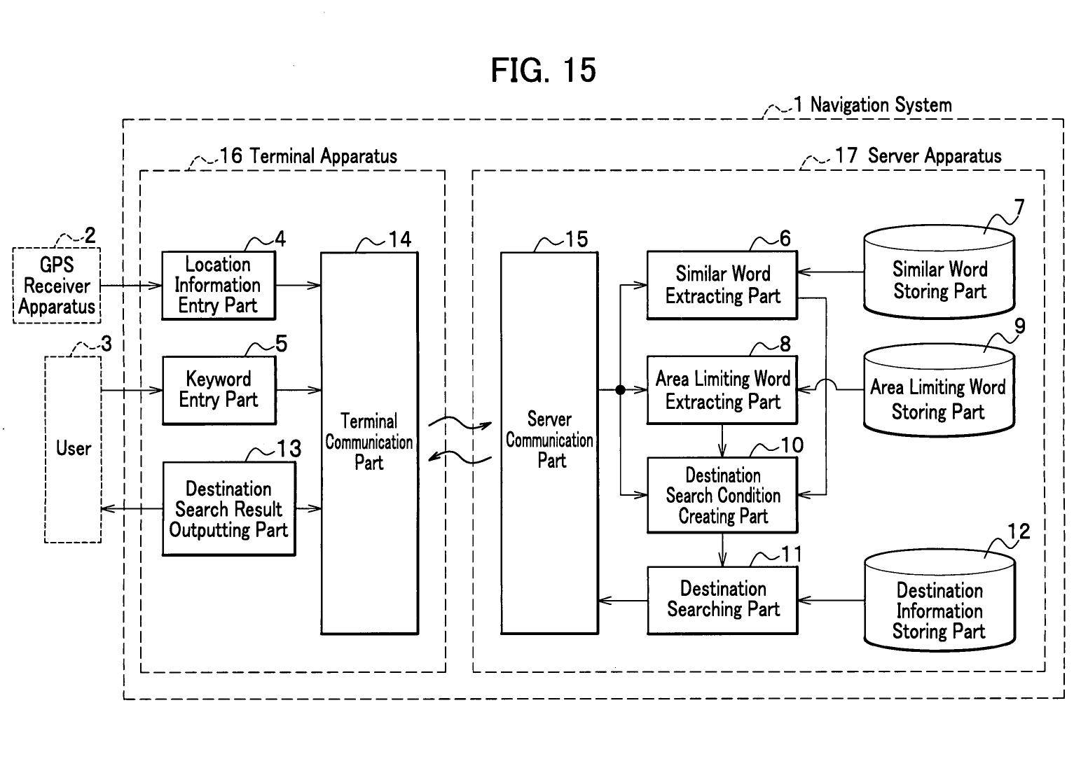

A second embodiment of the present invention will now be described in detail with reference to FIG. 15. FIG. 15 is a schematic which shows an example of a functional structure of the navigation system according to the second embodiment of the present invention. In FIG. 15, elements having the same functions as those of the navigation system according to the first embodiment shown in FIG. 1 are denoted with the same names and the same reference symbols.

A major difference of the second embodiment from the first embodiment is that the navigation system 1 is separated into a terminal apparatus 16 and a server apparatus 17 according to the second embodiment. The terminal apparatus 16 is mounted to a mobile body such as an automobile, while the server apparatus 17 is disposed in a fixed ground building. The terminal apparatus 16 comprises a terminal telecommunication part 14 which serves as telecommunication means, and the server apparatus 17 comprises a server telecommunication part 15 which serves as telecommunication means. The terminal telecommunication part 14 and the server telecommunication part 15 communicate with each other on a network including wireless telecommunication and the information is transferred between the terminal apparatus 16 and the server apparatus 17.

In FIG. 15, the terminal apparatus 16 comprises the location information entry part 4, the keyword entry part 5, the destination search result outputting part 13 and the terminal telecommunication part 14.

Current location information output from the GPS receiver apparatus 2 is entered via the location information entry part 4, while the keyword entry part 5 accepts a keyword keyed in or otherwise entered by the user 3. The terminal telecommunication part 14 sends the current location information and the information such as the keyword to the server apparatus 17. The terminal telecommunication part 14 also receives the information indicative of a destination search result sent from the server apparatus 17. The destination search result outputting part 13 constructs the display apparatus 26 and displays the result of a destination search received by the terminal telecommunication part 14.

In FIG. 15, the server apparatus 17 comprises the similar word extracting part 6, the similar word storing part 7, the area limiting word extracting part 8, the area limiting word storing part 9, the destination search condition creating part 10, the destination search part 11, the destination information storing part 12 and the server telecommunication part 15.

First, the server telecommunication part 15 receives the current location information and the information such as the keyword sent from the terminal apparatus 16. The similar word extracting part 6 searches the similar word storing part 7 based on the keywords received by the server telecommunication part 15, and extracts the similar words for each keyword. The area limiting word extracting part 8 searches the area limiting word storing part 9 similarly based on the received keywords, and extracts area limiting words for each keyword. The destination search condition creating part 10 then creates a search condition to search the destination information storing part 12, based on the current location information and the keyword received by the server telecommunication part 15, the similar words to the keyword extracted by the similar word extracting part 6 and the area limiting words extracted by the area limiting word extracting part 8. The destination search part 11 searches the destination information storing part 12 in accordance with the destination search condition created by the destination search condition creating part 10. The server telecommunication part 15 sends information indicative of the result of the search thus run to the terminal apparatus 16.

Although hardware structures of the terminal apparatus 16 and the server apparatus 17 are not shown in particular, as in the navigation system 1 according to the first embodiment shown in FIG. 2, each of these is formed by a computer which is comprised mainly of a CPU and a main storage device. Hence, the programs used in the first embodiment described with reference to FIGS. 3 through 14 are directly applicable to the second embodiment without a change to the basic procedure. However, since the terminal apparatus 16 and the server apparatus 17 each independent of each other comprise a CPU and a main storage device, when information is to be transferred between the programs belonging to the terminal apparatus 16 and the programs belonging to the server apparatus 17, it is necessary to add or modify a part of the procedure relevant to transfer of information. Nevertheless, addition or modification of the procedure can be performed regularly and is not an issue related to the essence of the invention, and hence, will not be described here.

Since the terminal apparatus 16 of the navigation system 1 according to the second embodiment does not have to store similar words, area limiting words, destination information, etc., the terminal apparatus 16 does not have to comprise any hardware which corresponds to the disk storage device 22. This permits a reduction in cost regarding the terminal apparatus 16. Additionally, the server apparatus 17 comprises the similar word storing part 7, the area limiting word storing part 9 and the destination information storing part 12, these pieces of information can be managed all together and may be changed in accordance with information at that time. For example, information indicative of how crowded a parking lot facility is, how much it has snowed at a ski resort, etc., may be stored as detailed information regarding the facilities. As the detailed information is shown to the user 3 who ran the search, the user 3 can obtain the most recent information.

The invention described above is not limited to the embodiments above but may be widely modified and implemented. For instance, in FIG. 15 which shows the second embodiment, the similar word storing part 7, the area limiting word storing part 9 and the destination information storing part 12 may be disposed in different server apparatuses or located at different places.

1. A navigation system which is mounted to a mobile body and displays route guidance information to a destination which said mobile body heads to, comprising:
a location information entry means which current location information regarding said mobile body is entered;
a keyword entry means which a keyword is entered for the purpose of a search for said destination which said mobile body heads to;
an area limiting word storing means which stores area limiting words whose meanings limit areas;
an area limiting word extracting means which extracts said area limiting words with reference to said area limiting word storing means in relation to keywords entered via said keyword entry means;
a destination information storing means which stores, for each destination, geographic information and other attribute information regarding said destination;
a destination search condition creating means which creates search conditions to search said destination information storing means based on said current location information entered via said location information entry means, said keywords entered via said keyword entry means and said area limiting words extracted by said area limiting word extracting means;
a destination search means which searches said destination information storing means in accordance with said search conditions created by said destination search condition creating means; and
a destination search result outputting means which displays the result of said search conducted by said destination search means.

2. A navigation system according to claim 1, separately comprising;
a terminal apparatus section which comprises said location information entry means, said keyword entry means and said search result outputting means and which is mounted to said mobile body;
a server apparatus section which comprises said area limiting word storing means, said area limiting word extracting means, said destination information storing means, said destination search condition creating means and said destination search means and which is disposed at a place remote from said mobile body,
wherein each one of said terminal apparatus section and said server apparatus section comprises a telecommunication means which realizes mutual telecommunications with each other, and via said telecommunication means, information is transferred with each other.

3. A navigation system according to claim 1, further comprising:
a similar word storing means which stores similar words for such words which can be entered as keywords via said keyword entry means; and
a similar word extracting means which, while referring to said similar word storing means, extracts similar words to said keywords in relation to said keywords entered via said keyword entry means,
wherein said destination search condition creating means creates a search condition to search said destination information storing means based on said current location information entered via said location information entry means, said keywords entered via said keyword entry means, said area limiting words extracted by said area limiting word extracting means, and additionally, said similar words to said keywords extracted by said similar word extracting means.

4. A navigation system according to claim 3, separately comprising;
a terminal apparatus section which comprises said location information entry means, said keyword entry means and said search result outputting means and which is mounted to said mobile body;
a server apparatus section which comprises said similar word storing means, said similar word extracting means, said area limiting word storing means, said area limiting word extracting means, said destination information storing means, said destination search condition creating means and said destination search means and which is disposed at a place remote from said mobile body,
wherein each one of said terminal apparatus section and said server apparatus section comprises telecommunication means which realizes mutual telecommunications with each other, and via said telecommunication means, information is transferred with each other.

5. A destination search method for use in a navigation system which comprises destination information storing means, which stores, for each destination which a mobile body heads to, geographic information and other attribute information regarding said destination, and an area limiting word storing means, which stores area limiting words whose meanings limit areas, and displays route guidance information to said destination which said mobile body heads to, said destination search method comprising:
a location information entry step of entering current location information regarding said mobile body;
a keyword entry step of entering keywords for searching for a destination which can be said destination which said mobile body heads to;
an area limiting word extracting step of extracting said area limiting words with reference to said area limiting word storing means in relation to keywords entered at said keyword entry step;
a destination search condition creating step of creating search conditions to search said destination information storing means based on said current location information entered at said location information entry step, said keywords entered at said keyword entry step and said area limiting words extracted at said area limiting word extracting step;
a destination search step of searching said destination information storing means in accordance with said search conditions created at said destination search condition creating step; and
a destination search result outputting step of displaying the result of said search conducted at said destination search step.

6. A destination search method for use in a navigation system which comprises a destination information storing means, which stores, for each destination which a mobile body heads to, geographic information and other attribute information regarding said destination, area limiting word storing means, which stores area limiting words whose meanings limit areas, and similar word storing means, which stores similar words to such words which can be entered as keywords, and displays route guidance information to said destination which said mobile body heads to, said destination search method comprising:
a location information entry step of entering current location information regarding said mobile body;
a keyword entry step of entering keywords for searching for a destination which can be said destination which said mobile body heads to;
a similar word extracting step of extracting said similar words to said keyword with reference to said similar word storing means in relation to said keywords entered at said keyword entry step;
an area limiting word extracting step of extracting said area limiting words with reference to said area limiting word storing means in relation to keywords entered via said keyword entry means;
a destination search condition creating step of creating search conditions to search said destination information storing means based on said current location information entered at said location information entry step, said keywords entered at said keyword entry step, said similar words to said keywords extracted by said similar word and said area limiting words extracted at said area limiting word extracting step;
a destination search step of searching said destination information storing means in accordance with said search conditions created at said destination search condition creating step; and
a destination search result outputting step of displaying the result of said search conducted at said destination search step.

7. A destination search program which makes a computer execute the destination search method of claim 5 for use in a navigation system.

8. A destination search program which makes a computer execute the destination search method of claim 6 for use in a navigation system.
